(19) United States
(12) Patent Application Publication
(10) Pub. No.: US 2012/0316760 A1
(43) Pub. Date: Dec. 13, 2012

(54) METHOD FOR OPERATING AN APPLIED-IGNITION INTERNAL COMBUSTION ENGINE WITH DIRECT INJECTION

(75) Inventors: Klemens Grieser, Langenfeld (DE); Oliver Berkemeier, Bergisch Gladbach (DE); Marco Marceno, Hagen (DE); Jan Linsel, Cologne (DE); Kay Hohenboeken, Koeln (DE); Jens Wojahn, Bergisch Gladbach (DE)

(73) Assignee: FORD GLOBAL TECHNOLOGIES, LLC, Dearborn, MI (US)

(21) Appl. No.: 13/472,340

(22) Filed: May 15, 2012

(30) Foreign Application Priority Data
Jun. 10, 2011 (DE) 102011077416.5

(51) Int. Cl. F02D 41/26; F02D 41/30

(52) U.S. Cl. 701/108; 701/103; 701/105

(57) ABSTRACT

Embodiments for operating an engine with direct injection are provided. In one example, a method for operating an applied-ignition internal combustion engine having at least one cylinder and direct injection comprises raising a component temperature of an injection device of the at least one cylinder at least locally in a region of a catalytic coating in order to initiate and assist oxidation of coking residues. Thus, deposits of coking residues may be counteracted even in part-load operation.

### RELATED APPLICATIONS

The present application claims priority to German Patent Application Number 102011077416.5, filed on Jun. 10, 2011, the entire contents of which are hereby incorporated by reference for all purposes.

### FIELD

The disclosure relates to a method for operating an applied-ignition internal combustion engine with an injection device having, at least in regions, a catalytic coating for the oxidation of coking residues.

### BACKGROUND AND SUMMARY

In the development of internal combustion engines, it is constantly sought to minimize fuel consumption and reduce pollutant emissions. A problem is fuel consumption in particular in applied-ignition engines. The reason for this lies in the principle of the working process of the traditional applied-ignition engine which is operated with a homogeneous fuel-air mixture, in which the desired power is set by varying the charge of the combustion chamber, that is to say by means of quantity regulation. By adjusting a throttle flap which is provided in the intake tract, the pressure of the inducted air downstream of the throttle flap can be reduced to a greater or lesser extent. For a constant combustion chamber volume, it is possible in this way for the air mass, that is to say the quantity, to be set by means of the pressure of the inducted air. However, quantity regulation by means of a throttle flap has thermodynamic disadvantages in the part-load range owing to the throttling losses.

One approach for de-throttling the applied-ignition engine working process consists in the development of hybrid combustion processes, and is based on the transfer of technical features of the traditional diesel engine process, which is characterized by air compression, a non-homogeneous mixture, auto-ignition and quality regulation. The low fuel consumption of diesel engines results inter alia from the quality regulation, in which the load is controlled by means of the injected fuel quantity.

The injection of fuel directly into the combustion chamber of the cylinder is therefore considered to be a suitable measure for noticeably reducing fuel consumption even in Otto-cycle engines. A certain degree of de-throttling of the internal combustion engine can be achieved already by virtue of quality regulation being used in certain operating ranges.

With the direct injection of the fuel into the combustion chamber, it is possible in particular to realize a stratified combustion chamber charge, which can contribute significantly to the de-throttling of the applied-ignition engine working process because, by means of stratified-charge operation, the internal combustion engine can be operated considerably leaner, which offers thermodynamic advantages in particular in the part-load range, that is to say in the low and medium load range, when only small fuel quantities are to be injected.

A stratified charge refers to a highly non-homogeneous combustion chamber charge which cannot be characterized by a uniform air ratio but which has both lean (λ>1) mixture parts and also rich (λ<1) mixture parts, wherein an ignitable fuel-air mixture with a relatively high fuel concentration is present in the region of the ignition device.

A relatively small amount of time is available for the injection of the fuel, for the mixture preparation in the combustion chamber, that is to say the mixing of air and fuel and the preparation including evaporation, and for the ignition of the prepared mixture.

Since only a small amount of time is available for the preparation of an ignitable and combustible fuel-air mixture as a result of the direct injection of the fuel into the combustion chamber, direct-injection applied-ignition engine processes are significantly more sensitive to changes and deviations in the mixture formation, in particular in the injection and the ignition, than conventional applied-ignition engine processes.

The non-homogeneity of the fuel-air mixture is also the reason why the particle emissions known from the diesel engine process are likewise of relevance in the case of the direct-injection applied-ignition engine, whereas said emissions are of almost no significance in the case of the traditional applied-ignition engine.

In the case of the direct injection of fuel, problems are caused by the coking of the injection device, for example of an injection nozzle which is used for the injection. Here, extremely small quantities of fuel which adhere to the injection device during the injection undergo incomplete combustion under oxygen-deficient conditions.

Deposits of coking residues form on the injection device. Said coking residues may firstly disadvantageously change the geometry of the injection device and influence or hinder the formation of the injection jet, and thereby disrupt the sensitive mixture preparation.

Secondly, injected fuel accumulates in the porous coking residues, which fuel, often toward the end of the combustion when the oxygen provided for the combustion has been almost completely consumed, then undergoes incomplete combustion and forms soot, which in turn contributes to the increase in particle emissions.

Furthermore, coking residues may become detached for example as a result of mechanical loading caused by a pressure wave propagating in the combustion chamber or the action of the injection jet. The residues detached in this way may lead to damage in the exhaust-gas discharge system, and for example impair the functional capability of exhaust-gas aftertreatment systems provided in the exhaust-gas discharge system.

Concepts are known which are intended to counteract the build-up of coking residues and/or which serve to deplete deposits of coking residues, that is to say to remove said coking residues from and clean the combustion chamber.

The German laid-open specification DE 199 45 813 A1 describes a method for operating a direct-injection internal combustion engine, in which method, upon the detection of deposits in the combustion chamber, for example on an injection valve, measures are implemented in a targeted manner for cleaning the combustion chamber, wherein the presence of deposits in the combustion chamber is inferred from a misfire detection system. Measures proposed for cleaning the combustion chamber include the targeted initiation of knocking combustion and/or the introduction of a cleaning fluid into the intake combustion air. Both measures may be regarded as important with regard to fuel consumption and pollutant emissions.

Proposed as a particularly advantageous cleaning fluid is water, the injection of which causes the combustion temperature to be lowered, as a result of which the emissions of nitrogen oxides (NOₓ) can be simultaneously reduced. The injection of water is however not suitable in part-load operation at low loads and low rotational speeds, because this harbors the risk of corrosion in the combustion chamber and in the exhaust-gas discharge system, and can yield disadvantages in terms of wear.

The European patent EP 1 404 955 B1 describes an internal combustion engine whose at least one combustion chamber has, at least in regions, a catalytic coating on the surface for the purpose of oxidation of coking residues. The catalytic layer is intended to promote the oxidation of coking residues, specifically to affect a fast oxidation of the carbon-containing lining at a boundary surface between the catalytic converter and lining at typical operating temperatures, and to thereby effect an early detachment of the deposit under the action of the prevailing flow. In this way, growth of the residues is reduced or even completely prevented.

A disadvantage of the method described in EP 1 404 955 B1 for the reduction of coking residues by means of oxidation is that, even when using catalytic materials, the minimum temperatures required for the oxidation are not always reached in part-load operation at low loads and low rotational speeds. It is however precisely these operating conditions of the internal combustion engine, specifically low loads and/or low rotational speeds, that promote, that is to say expedite, the formation of deposits of the type in question, and that necessitate a method for removing said deposits.

The above-described problem takes on an even greater significance during the warm-up phase of the internal combustion engine, in particular directly after a cold start of the internal combustion engine, when the component temperatures are particularly low. This is because the low temperature level not only expedites the formation of coking residues but also makes the removal of said residues more difficult.

The inventors herein have recognized the issues with the above approaches and provide a method to at least partly address them. In one embodiment, a method for operating an applied-ignition internal combustion engine having at least one cylinder and direct injection comprises raising a component temperature of an injection device of the at least one cylinder at least locally in a region of a catalytic coating in order to initiate and assist oxidation of coking residues.

In this way, the temperature of the injection device is raised in a targeted manner in the region of the catalytic coating. The increased temperature, in interaction with the catalytic materials used, has the effect that the minimum temperatures required for the oxidation of coking residues are reached even in part-load operation. Thus, the deposits of coking residues can be counteracted even in part-load operation.

In contrast to the method described in EP 1 404 955 B1, in which the temperature is not influenced in a targeted manner, in particular is not raised, the method of the present disclosure does not rely on the temperatures required for the oxidation of coking residues being attained during the normal operation of the internal combustion engine, that is to say on the depletion as a result of the normal operating temperatures, because this does not ensure cleaning of the injection device in part-load operation.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows the combustion chamber of a cylinder in cross section.

FIG. 2 schematically shows a vehicle system including the cylinder of FIG. 1.

FIG. 3 is a flow chart illustrating a method for operating an engine with direct injection.

### DETAILED DESCRIPTION

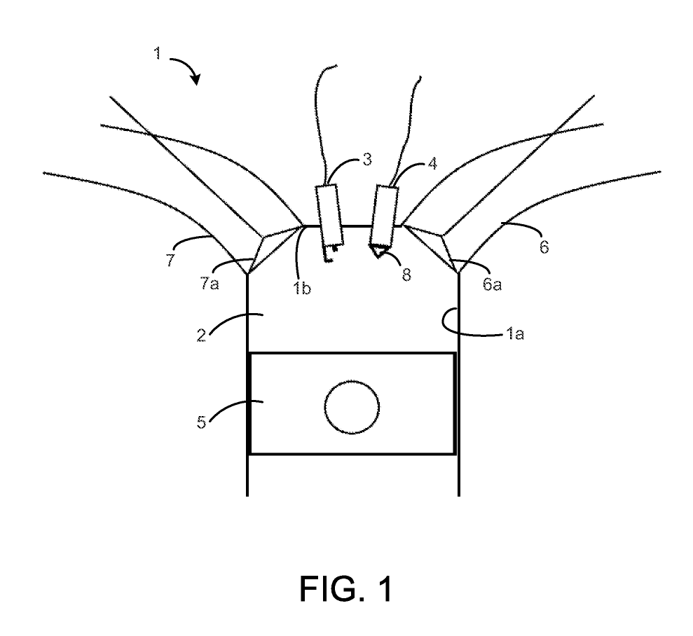

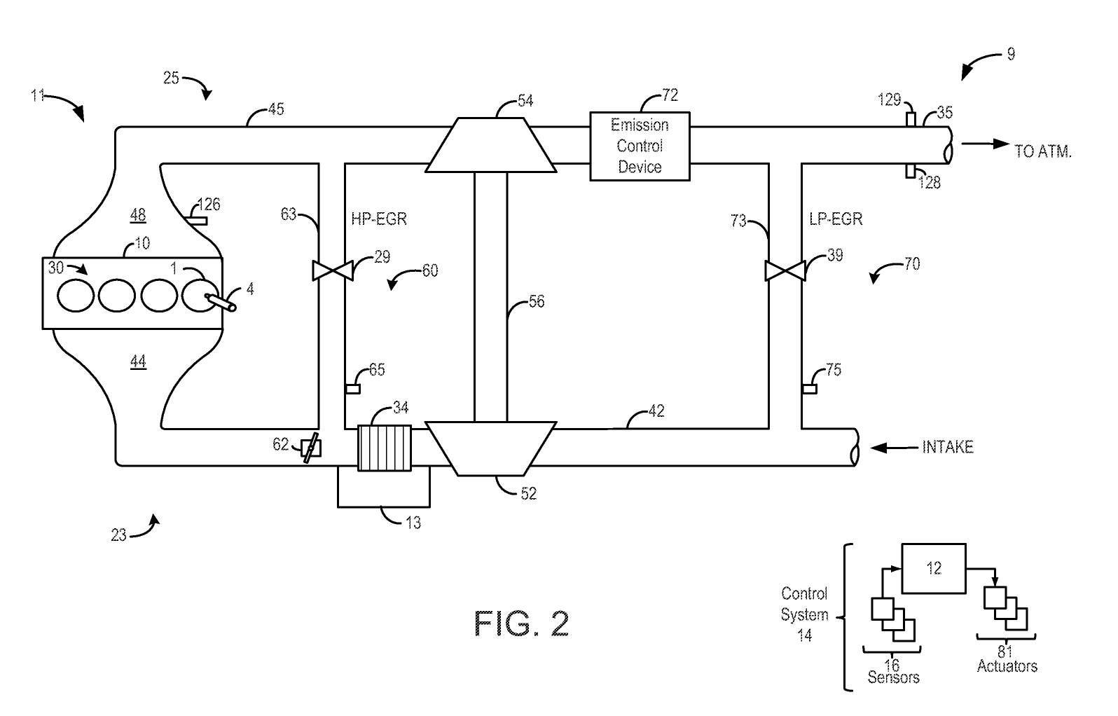

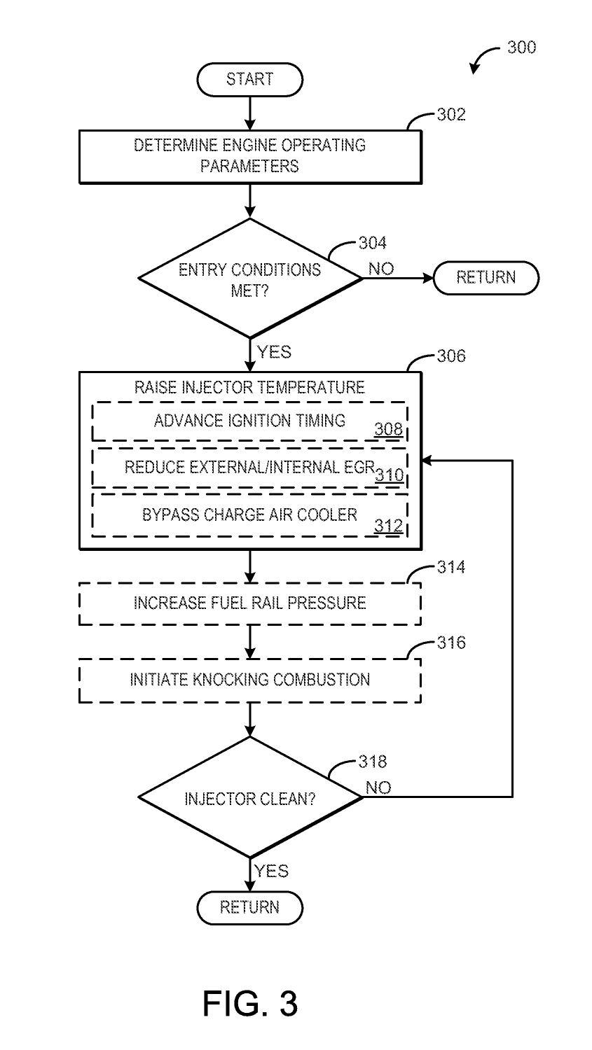

Direct-injection engines may produce particulate matter as a by-product of combustion, particularly during low speed/load operation. This particulate matter may build on the fuel injectors arranged in the combustion chamber, leading to fueling errors and component damage. To remove such coking residue from the injectors, the injectors may be coated at least partially in a catalyst coating configured to oxidize the particulates at relatively high temperature. During low speed/load operation or when engine temperature is below a threshold, injector temperature may be increased by advancing spark timing, reducing EGR flow, or other mechanisms, in order to initiate oxidation of the particulates. Further, fuel rail pressure may be increased and/or knock combustion initiated to physically remove some or all of the particulates from the injector. FIG. 1 depicts a cylinder including an injector device coated with a catalyst material. FIG. 2 is a vehicle system including the cylinder of FIG. 1 and a controller configured to carry out the method of FIG. 3.

As will be described in more detail below with respect to FIG. 3, a method may be carried out to remove coking residues deposited on the injector. Examples of the method are advantageous in which the cleaning by oxidation is initiated upon the detection of a predefinable amount of coking residues deposited on the injection device. In this connection, examples of the method are advantageous in which the amount of coking residues deposited on the injection device is estimated by a mathematical model, and the amount determined in this way is compared with the predefinable amount, the cleaning by oxidation being initiated when the predefinable amount is exceeded.

Examples of the method are also advantageous in which the cleaning by oxidation is initiated when a predefinable operating duration of the internal combustion engine is exceeded or when a vehicle in which the internal combustion engine is used has traveled a predefinable distance.

Examples of the method are advantageous in which the cleaning by oxidation is carried out at low load and low rotational speed of the internal combustion engine.

As has already been stated, it is possible with the method according to the disclosure for the deposits of coking residues to be counteracted even in the part-load range.

Carrying out the method at low load and low rotational speed of the internal combustion engine, as per the embodiment in question, is advantageous because these operating conditions of the internal combustion engine expedite the formation and deposit of coking residues. At low load and low rotational speed, therefore, the utilization of a method for removing said deposits is particularly great.

Examples of the method are advantageous in which the injection pressure with which the injection device injects fuel into the combustion chamber is increased in order to assist the cleaning by means of oxidation. It is assumed here that the fuel jet entering the combustion chamber acts on the deposits and partially detaches the deposits, wherein the action of the fuel jet increases with the injection pressure.

Examples of the method are advantageous in which knocking combustion is initiated in order to assist the cleaning by oxidation. The pressure oscillations generated as a result of the knocking combustion are superposed on the normal pressure profile and generate intense high-frequency vibrations which can remove the deposits. The knocking combustion should however be used only briefly to assist the cleaning by oxidation, because said knocking combustion also subjects the other components to high loading and can cause damage.

Examples of the method are advantageous in which the component temperature of the injection device is raised by virtue of the ignition time being shifted in the early direction.

An adjustment of the ignition time in the early direction, for example in the direction of smaller crank angles proceeding from a working cycle covering 720° CA, shifts the concentration point of the combustion, that is to say the combustion process, into the vicinity of top dead center, or into the compression phase. By doing so, the process pressures and process temperatures can be increased. The higher combustion temperatures inevitably also lead to higher component temperatures, in particular to higher temperatures of the components and walls which delimit the combustion chamber, and therefore also to a higher component temperature of the injection device.

In this connection, examples of the method are advantageous in which the component temperature of the injection device is raised by virtue of the ignition time being shifted in the early direction proceeding from an ignition time which is optimized with regard to fuel consumption. Said method variant makes allowance for the fact that the operating parameters of an internal combustion engine are preferably calibrated and fixed so as to obtain low fuel consumption and good emissions characteristics.

If a shift of the ignition time in the early direction is used for raising the temperature, the ignition time can be shifted in the late direction, back to the ignition time which is optimized with regard to fuel consumption, after the method according to the disclosure as per the variant in question has been carried out.

Examples of the method are advantageous in which the component temperature of the injection device is raised by virtue of the combustion gas fraction of the cylinder fresh charge being reduced. The combustion gases may be recirculated exhaust gas and/or residual gas remaining in the cylinder.

The temperature of the cylinder fresh charge generally rises when the combustion gas fraction increases. The rate of combustion at which the fuel-air mixture burns after the initiation of the ignition however simultaneously decreases with increasing combustion gas fraction. The reduced rate of combustion leads to lower process pressures and lower process temperatures. Conversely, the process temperatures can consequently be increased by virtue of the combustion gas fraction of the cylinder fresh charge being reduced. As already described above in another context, the higher process temperatures lead to higher component temperatures, in particular also to a higher temperature of the injection device.

For the reasons stated, in the case of internal combustion engines equipped with an exhaust-gas recirculation system, examples of the method are advantageous in which the component temperature of the injection device is raised by virtue of the exhaust-gas quantity recirculated by the exhaust-gas recirculation system being reduced.

In this connection—alternatively or in addition—examples of the method are also advantageous in which the component temperature of the injection device is raised by virtue of the residual gas quantity remaining in the at least one cylinder after a charge exchange being reduced. The reasons are those that have already been stated above.

In the case of internal combustion engines which are equipped with an at least partially variable valve timing system, examples of the method are advantageous in which the residual gas quantity is reduced by decreasing the valve overlap.

Exhaust-gas recirculation (EGR), that is to say the recirculation of exhaust gas from the exhaust-gas side to the intake side, is a concept for reducing nitrogen oxide emissions, since exhaust-gas recirculation lowers the combustion temperatures, and the formation of nitrogen oxides requires not only an excess of air but also high temperatures. With increasing exhaust-gas recirculation rate, the nitrogen oxide emissions can be considerably reduced.

If the internal combustion engine is supercharged by an exhaust-gas turbocharger, different EGR concepts can be realized. In the case of a high-pressure EGR arrangement, the exhaust gas is extracted from the exhaust line upstream of the turbine and introduced into the intake line downstream of the compressor, whereas in the case of a low-pressure EGR arrangement, exhaust gas which has already flowed through the turbine is recirculated to the inlet side. For this purpose, the low-pressure EGR arrangement comprises a recirculation line which branches off from the exhaust line downstream of the turbine and opens into the intake line upstream of the compressor.

If the internal combustion engine is equipped with a liquid-cooling arrangement, examples of the method are advantageous in which the component temperature of the injection device is raised by virtue of the temperature of the cooling liquid of the liquid-cooling arrangement being raised. The less heat is dissipated by cooling liquid, the higher the component temperatures, and therefore the higher the component temperature of the injection device, which is of relevance in the present case. Furthermore, as a result of the raising of the temperature of the cooling liquid, less fuel is accumulated or deposited in the coking residues.

In the case of internal combustion engines equipped with a charge-air cooling device, examples of the method are advantageous in which the component temperature of the injection device is raised by virtue of the charge-air cooling device being bypassed.

In the case of supercharged internal combustion engines a charge-air cooler is often provided in the intake line downstream of the compressor, by which charge-air cooler the compressed charge air is cooled before it enters the at least one cylinder. The cooler lowers the temperature and thereby increases the density of the charge air, such that the cooler also contributes to improved charging of the cylinders, that is to say to a greater air mass. Compression by cooling takes place here.

In contrast, if it is sought to raise the component temperature of the injection device, it is advantageous, in accordance with the present method variant, for the charge-air cooling means to be bypassed.

FIG. 1 schematically shows the combustion chamber 2 of a cylinder 1 in cross section. The cylinder 1 has a cylinder bore or a cylinder liner 1a for receiving a piston 5. The piston 5 is guided in an axially movable manner in the cylinder liner 1a and forms, together with the cylinder liner 1a and the cylinder roof 1b, the combustion chamber 2 of the cylinder 1.

During the course of the charge exchange, the discharge of the combustion gases out of the cylinder 1 takes place via the exhaust line 7, and the charging of the combustion chamber 2 with charge air takes place via the intake line 6. To control the charge exchange, use is made of an outlet valve 7a and an inlet valve 6a which, during the operation of the internal combustion engine, perform an oscillating lifting movement and thereby open up and close off the exhaust line 7 and the intake line 6.

The intake and exhaust valve timing may be controlled concurrently or any of a possibility of variable intake cam timing, variable exhaust cam timing, dual independent variable cam timing or fixed cam timing may be used. Each cam actuation system may include one or more cams and may utilize one or more of cam profile switching (CPS), variable cam timing (VCT), variable valve timing (VVT) and/or variable valve lift (VVL) systems that may be operated by a controller to vary valve operation. For example, cylinder 1 may include an intake valve controlled via electric valve actuation, and an exhaust valve controlled via cam actuation including CPS and/or VCT. In other embodiments, the intake and exhaust valves may be controlled by a common valve actuator or actuation system, or a variable valve timing actuator or actuation system. The engine may further include a cam position sensor whose data may be merged with the crankshaft position sensor to determine an engine position and cam timing.

The cylinder 1 illustrated in FIG. 1 has applied ignition and direct injection, wherein in the cylinder roof 1b there are provided an ignition device 3, such as a spark plug, and an injection device 4, such as an injection nozzle, for the direct injection of fuel into the combustion chamber 2 of the cylinder 1.

The injection nozzle has, at least in regions, a catalytic coating 8 for the oxidation of coking residues. In order to initiate and assist the oxidation of coking residues for the purpose of cleaning, the component temperature of the injection nozzle is raised at least locally in the region of the catalytic coating 8.

FIG. 2 shows a schematic depiction of a vehicle system 9. The vehicle system 9 includes an engine system 11 coupled to an exhaust treatment system 22. The engine system 11 may include an engine 10 having a plurality of cylinders 30. Cylinder 1 of FIG. 1 may be included in the plurality of cylinders 30. The engine 10 includes an intake 23 and an exhaust 25. The intake 23 includes a throttle 62 fluidly coupled to the engine intake manifold 44 via an intake passage 42. The exhaust 25 includes an exhaust manifold 48 leading to an exhaust passage 45 that routes exhaust gas to the atmosphere via tailpipe 35. Exhaust passage 45 may include one or more emission control devices 72, which may be mounted in a close-coupled position in the exhaust. One or more emission control devices may include a three-way catalyst, lean NOx trap, oxidation catalyst, etc.

Fuel may be delivered to fuel injector 4 from a high pressure fuel system including a fuel tank, fuel pumps, and a fuel rail. Alternatively, fuel may be delivered by a single stage fuel pump at lower pressure. Further, while not shown, the fuel tank may have a pressure transducer providing a signal to controller 12.

Engine 10 may further include a boosting device, such as a turbocharger, including a compressor 52 arranged along intake passage 42. Compressor 52 may be at least partially driven by a turbine 54, arranged along exhaust passage 45, via shaft 56. In alternate embodiments, the boosting device may be a supercharger, wherein compressor 52 may be at least partially driven by the engine and/or an electric machine, and may not include a turbine. The amount of boost (or compression) provided to one or more cylinders of the engine via a turbocharger or supercharger may be varied by controller 12. In some embodiments, an optional charge after-cooler 34 may be included downstream of compressor 52 in intake passage 42. The after-cooler may be configured to reduce the temperature of the intake air compressed by the boosting device. The after-cooler may include a bypass line 13 in order to divert intake air around the cooler.

Engine 10 may further include one or more exhaust gas recirculation (EGR) systems configured to route a portion of exhaust gas from exhaust passage 45 to intake passage 42. For example, engine 10 may include a first high pressure-EGR (HP-EGR) system 60 and a second low pressure-EGR (LP-EGR) system 70. HP-EGR system 60 may include HP-EGR passage 63, HP-EGR valve 29, and HP-EGR cooler 64. Specifically, HP-EGR passage 63 may be configured to route a portion of exhaust gas from exhaust passage 45, upstream of turbine 54, to intake passage 42, downstream of compressor 52, and upstream of throttle 62. As such, HP-EGR system 60 may be operated when no boost is provided by the boosting device. LP-EGR system 70 may include LP-EGR passage 73 and LP-EGR valve 39. LP-EGR passage 73 may be configured to route a portion of exhaust gas from exhaust passage 45, downstream of turbine 54, to intake passage 42, upstream of compressor 52 and throttle 62. LP-EGR system 70 may be operated in the presence or absence of boost from the boosting device. It will be appreciated that other components may be included in engine 10, such as a variety of valves and sensors.

The amount and/or rate of HP-EGR provided to intake manifold 44 may be varied by controller 12 via HP-EGR valve 29. HP-EGR sensor 65 may be positioned within HP-EGR passage 63 to provide an indication of one or more of a pressure, temperature, composition, and concentration of exhaust gas recirculated through HP-EGR system 60. Similarly, the amount and/or rate of LP-EGR provided to intake passage 42 may be varied by controller 12 via LP-EGR valve 39. LP-EGR sensor 75 may be positioned within LP-EGR passage 73 to provide an indication of one or more of a pressure, temperature, composition, and concentration of exhaust gas recirculated through LP-EGR system 70.

Under some conditions, exhaust gas recirculation through HP-EGR system 60 and/or LP-EGR system 70 may be used to regulate the temperature of the air and fuel mixture within the intake manifold, and/or reduce NOₓ formation of combustion by reducing peak combustion temperatures, for example. As elaborated herein with reference to FIG. 3, under some conditions, for example increased particulate load on a fuel injector, an EGR flow through HP-EGR system 60 and/or the LP-EGR system 70 may be reduced in order to increase combustion temperatures and hence initiate oxidation of the particulates built up on the fuel injector.

Engine 10 may be controlled at least partially by a control system 14 including controller 12 and by input from a vehicle operator via an input device (not shown). Control system 14 is shown receiving information from a plurality of sensors 16 (various examples of which are described herein) and sending control signals to a plurality of actuators 81 (various examples of which are described herein). As one example, sensors 16 may include exhaust gas sensor 126 located upstream of the emission control device, exhaust temperature sensor 128 and exhaust pressure sensor 129 located downstream of the emission control device and exhaust treatment system in tailpipe 35, HP-EGR sensor 65 located in HP-EGR passage 63, and LP-EGR sensor 75 located in LP-EGR passage 73. Other sensors such as additional pressure, temperature, air/fuel ratio and composition sensors may be coupled to various locations in the vehicle system 9. As another example, actuators 81 may include fuel injector 4, HP-EGR valve 29, LP-EGR valve 39, and throttle 62. Other actuators, such as a variety of additional valves and throttles, may be coupled to various locations in the vehicle system 9. Controller 12 may receive input data from the various sensors, process the input data, and trigger the actuators in response to the processed input data based on instruction or code programmed therein corresponding to one or more routines. An example control routine is described herein with regard to FIG. 3.

FIG. 3 is a flow chart illustrating a method 300 for initiating oxidation of particulate matter built up on a fuel injector that includes a catalyst coating, such as fuel injector 4. Method 300 may be carried out by controller 12 according to instructions stored therein. At 302, method 300 includes determining engine operating parameters. The determined engine operating parameters may include engine speed, engine load, engine temperature, fuel composition, etc. At 304, it is determined if injector cleaning entry conditions have been met. The entry conditions may include a particulate load on the injector exceeding a threshold. The particulate load may be estimated based on a model that tracks certain operating parameters, such as speed, load, injector tip temperature, fuel composition, and other parameters, over a duration to determine the amount of particulates expected to have built up on the injector tip. The threshold may be a suitable threshold above which the particulate matter on the injector may clog the injector tip or otherwise cause fueling errors. The entry conditions may also include the engine speed and load being in the low to mid speed/load range. At higher speeds/loads, the temperature in the combustion chamber may be high enough to initiate the oxidation of the particulate on the injector, and thus the cleaning routine may only be carried out when engine speed and load are low. Further, in other embodiments, the entry conditions may include an amount of time, engine cycles, miles driven, etc. that have lapsed since a previous cleaning routine.

If the entry conditions have not been met, method 300 returns. If the entry conditions are met, such as if the particulate load on the injector exceeds the threshold, method 300 proceeds to 306 to raise the injector tip temperature. As explained previously, the injector may be coated with a catalyst at least in some regions. The catalyst may oxidize the particulates built up on the injector when the injector temperature is high enough. Thus, when the particulate load on the injector exceeds the threshold, the temperature of the injector may be increased to oxidize the particulates.

The injector temperature may be raised by raising overall combustion chamber temperature. This may include advancing spark timing at 308, reducing external/internal EGR at 310, and/or bypassing a charge-air cooler at 312. Spark timing may be advanced relative to an optimal setting for the operating conditions, such maximum brake torque (MBT) ignition timing, while accounting for additional torque requests, combustion conditions, etc. External EGR may be reduced by adjusting the position of one or more EGR valves, such as HP-EGR valve 29 and LP-EGR valve 39, in order to reduce EGR flow into the cylinder. Internal EGR may be reduced by adjusting intake/exhaust valve timing. For example, the amount of intake/exhaust valve overlap may be reduced to reduce the fraction of combusted gas remaining in the cylinder. Other mechanisms for selectively increasing cylinder temperature are also within the scope of this disclosure, such as adjusting air-fuel ratio.

At 314, the fuel rail pressure is optionally increased. If increasing the fuel injector temperature is not sufficient to oxidize the particulates, for example if the initial engine temperature is low and the mechanisms to heat the injector tip do not get the injector hot enough to oxidize the particulates, or if operating constraints restrict the ability to raise the injector tip temperature, the particulates may be physically removed from the injector by increasing the pressure at which the fuel exits the injector. Additionally or alternatively, the engine may be optionally operated with knock combustion at 316 to generate pressure waves that may remove the particulates from the injector. Knock combustion may be initiated by interrupting injection of knock control fluids, and/or by adjusting air-fuel ratio, ignition timing, and manifold pressure, or other mechanisms.

At 318, it is determined if the injector has been fully cleaned. This may be determined based on a duration and degree of the raising of the injector temperature, and/or based on the duration and degree of increased fuel rail pressure and knock combustion. If it is determined the injector has not been fully cleaned, method 300 returns to 306 to continue to raise the injector tip temperature. If the injector has been fully cleaned, method 300 returns.

Thus, method 300 provides for a method for an engine including a cylinder, comprising if a particulate load on a fuel injector positioned in the cylinder exceeds a threshold then advancing spark timing to increase cylinder temperature to initiate oxidation of the particulates. The particulate load on the fuel injector may be based on injector tip temperature, fuel composition, engine speed, and engine load. The method may also include reducing a cylinder EGR fraction to increase cylinder temperature, and, if engine temperature is below the threshold, increasing fuel rail pressure. In this way, responsive to coking residues deposited on the injector, cylinder temperature and hence injector temperature may be increased by advancing spark timing. Further, if engine temperature is below a threshold, such following a cold start, additional mechanisms may be utilized to remove the coking residues, such as generating cylinder knock.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating an applied-ignition internal combustion engine having at least one cylinder and direct injection, comprising:
raising a component temperature of an injection device of the at least one cylinder at least locally in a region of a catalytic coating in order to initiate and assist oxidation of coking residues.

2. The method as claimed in claim 1, wherein the raising of the component temperature is initiated upon detection of a predefinable amount of coking residues deposited on the injection device.

3. The method as claimed in claim 2, wherein the amount of coking residues deposited on the injection device is estimated by a mathematical model, and further comprising comparing the estimated amount with the predefinable amount, and initiating the raising of the component temperature when the predefinable amount is exceeded.

4. The method as claimed in claim 1, wherein the raising of the component temperature is initiated when a predefinable operating duration of the internal combustion engine is exceeded or when a vehicle in which the internal combustion engine is used has traveled a predefinable distance.

5. The method as claimed in claim 1, wherein the raising of the component temperature is carried out at low load and low rotational speed of the internal combustion engine.

6. The method as claimed in claim 1, wherein the injection pressure with which the injection device injects fuel into the combustion chamber is increased in order to remove coking residues.

7. The method as claimed in claim 1, wherein knocking combustion is initiated in order to remove coking residues.

8. The method as claimed in claim 1, wherein the component temperature of the injection device is raised by virtue of an ignition time being shifted in an early direction.

9. The method as claimed in claim 8, wherein the component temperature of the injection device is raised by virtue of the ignition time being shifted in the early direction proceeding from an ignition time which is optimized with regard to fuel consumption.

10. The method as claimed in claim 1, wherein the component temperature of the injection device is raised by virtue of a combustion gas fraction of a cylinder fresh charge being reduced.

11. The method as claimed in claim 10, further comprising operating an exhaust-gas recirculation system, and wherein the component temperature of the injection device is raised by virtue of an exhaust-gas quantity recirculated by the exhaust-gas recirculation system being reduced.

12. The method as claimed in claim 10, wherein the component temperature of the injection device is raised by virtue of a residual gas quantity remaining in the at least one cylinder after a charge exchange being reduced.

13. The method as claimed in claim 12, further comprising operating an at least partially variable valve timing system, wherein the residual gas quantity is reduced by decreasing valve overlap.

14. The method as claimed in claim 1, wherein the internal combustion engine is equipped with a liquid-cooling arrangement, and wherein the component temperature of the injection device is raised by virtue of a temperature of a cooling liquid of the liquid-cooling arrangement being raised.

15. The method as claimed in claim 1, wherein the internal combustion engine is equipped with a charge-air cooling device, wherein the component temperature of the injection device is raised by virtue of the charge-air cooling device being bypassed.

16. A method for an engine including a cylinder, comprising:
if a particulate load on a fuel injector positioned in the cylinder exceeds a threshold, advancing spark timing to increase cylinder temperature to initiate oxidation of the particulates.

17. The method of claim 16, further comprising determining the particulate load on the fuel injector based on injector tip temperature, fuel composition, engine speed, and engine load.

18. The method of claim 16, further comprising reducing a cylinder EGR fraction to increase cylinder temperature.

19. The method of claim 16, further comprising, if engine temperature is below a threshold, increasing fuel rail pressure.

20. A method for a spark-ignition direct injection engine, comprising:
if a particulate load on a fuel injector exceeds a threshold, advancing spark timing and reducing valve overlap to increase cylinder temperature and initiate oxidation of the particulates via a catalyst coating on the fuel injector.
